(19) United States
(12) Patent Application Publication
(10) Pub. No.: US 2009/0048853 A1
(43) Pub. Date: Feb. 19, 2009

(54) PERMISSION BASED FIELD SERVICE MANAGEMENT SYSTEM

(76) Inventor: Jeffrey Hall, San Jose, CA (US)

Correspondence Address: HEALTH HERO NETWORK, INC., 2400 GENG ROAD, SUITE 200, PALO ALTO, CA, 94303, US

(21) Appl. No.: 11/837,970

(22) Filed: Aug. 13, 2007

(51) Int. Cl. G06Q 99/00

(52) U.S. Cl. 705/1

(57) ABSTRACT

The embodiments of herein provide a permission based field service management system and method for field services using a permission slip. A technician allotted to perform a field service is authenticated by a client/server software system and provided with a work list. When the technician accepts a work list, a permission slip corresponding to a specific device is entered in a service key inserted by the technician into a client. Then the service key is removed and inserted into a specific device to execute a field service operation. After the completion of the field service operation, the permission slip is closed and a service log is created and stored on a service database. An auditing system accesses the service data to track and monitor the service operation.

### BACKGROUND

1. Technical field

The embodiments herein generally relate to a field service management system for electronic devices, and, more specifically, to a permission based field service management system for electronic devices such as medical devices.

2. Description of the Related Art

Field service management (FSM), also known as field force automation (FFA), is an attempt to optimize processes and information needed by companies and service providers who send technicians or staff into the field (or out of the office) for providing required service. Field service mostly refers to the installation, service, or repairs of systems or equipments. Field service management involves performing some or all of the following operations: computer related maintenance applications, work order management, dispatch, and maintaining historical customer service data. Field service software combines many of these functions into one unified solution. The field service software may also utilize databases containing details on customer premise equipment, access requirements, and parts inventory. Many field service management solutions integrate with other software such as accounting programs like QuickBooks. Moreover, this type of software improves field worker productivity, enhances customer service, automates paper processes, and assists with regulatory compliance.

Field service management software is often referred to as a service management software, computerized maintenance management system (CMMS), work order software, service order software, scheduling or dispatch software. A CMMS software package maintains an information database to store information about maintenance operations. This information is intended to help maintenance workers operate more effectively and assist management in determining cost of maintenance for each piece of equipment used by the organization to allocate resources effectively. CMMS software packages may be used by any organization that must perform maintenance on equipment and property. Additionally, some CMMS software packages focus on particular industry sectors (e.g. the maintenance of vehicle fleets or health care facilities). Further, CMMS software packages may produce status reports and documents giving details or summaries of maintenance activities.

A wide variety of field service management systems have been developed for tracking of field work or for providing required information to a field engineer, but existing systems are not capable of providing a solution for the accountability and the traceability for a field service operation. The currently available field service management systems also do not provide verification and scheduling methods for field service operations. Hence, there is a need to develop a field service management system and method, which may be used to authenticate service personnel to perform a field service operation on an electronic device located at the premises of a customer, to monitor maintenance operations, to maintain a service log, and to perform the auditing of field service data effectively and quickly.

### SUMMARY

In view of the foregoing, the embodiments herein provide a field service management system and method to perform and trace a field service operation using a permission slip. According to one embodiment, a permission based field service management method is provided for performing a field service operation on an electronic device at the customer's premises using a permission slip. The method involves authorizing a service technician to perform a specific service process on a predetermined device by issuing a permission slip containing the identification of the device on which a service is to be performed and a service key. The permission slip is closed after completion of the service operation. A log containing the data regarding the maintenance performed on the device is maintained to keep track of the service operation performed on the device using the permission slip.

A field service technician (hereinafter “technician”) assigned to perform a field service operation is authenticated based on the input of his/her user name and password. A work list containing the number of specific devices requiring field service and the addresses of the devices is provided to the authenticated technician. After the acceptance of the work list by the technician, a service key containing a permission slip for each device is provided to the technician to execute a specific service operation. The permission slip contains a unique service authorization code, a unique device identification code, and a user name of any technician authorized to carry out a maintenance operation. When the technician inserts his/her service key in a device under maintenance, the permission slip provided to the technician is read from the service key and examined to authenticate the technician and the service to be performed. After completion of the service operation, data related to the service performed on the device is entered into the device and on the service key. The service data is then uploaded to a server to maintain a separate field service log which is accessible to a care manager.

The permission slip may be a generic permission slip (GPS) or a specific permission slip (SPS). The generic permission slips are the permission slips for the devices that are to be serviced in bulk, for example, mass ROM updating of the devices in stock. The specific permission slips are issued for the devices that need specific service as a result of a customer request. These permission slips relate to a specific device/patient. Client software provides the technician with the name, address, and phone number of the location of the device/patient, whereby the technician may perform the service operation at the patient's location, if needed.

Additionally, the embodiments herein provide a permission based field service management system that may perform a field service on an electronic device at the premises of a customer using a permission slip. A client/server subsystem stores on a service key, a permission slip for executing a specific service on a specific field device based on a service request received from the client/server subsystem, after authenticating the service technician with the user name and the password. The permission slip contains the device identification and identification of the technician authorized to perform the field service. The permission slip may be a specific permission slip issued to perform a field service on a specific device or a generic permission slip issued to perform a service on several devices. The technician inserts the acquired service key on a device on which a service is to be performed. After authenticating the technician and the device identity, the technician is permitted to carry out a specified field service on the specified device. The date related to the service operation is entered on the service key after the completion of the service operation. Then the service key is removed from the device and inserted into to the client/server system to close the permission slip. The service data is stored on the field device and in a service database to enable the auditing of the service done on the field device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be mad e within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a functional block diagram of a permission based field service management system according to an embodiment herein;

FIG. 2 illustrates a functional block diagram of a permission based field service client/server subsystem according to an embodiment herein;

FIG. 3 illustrates a functional block diagram of a permission based field service client/server subsystem with virtualized key according to an embodiment herein; and

FIG. 4 illustrates a method for performing on a field device using a permission based field service management system according to one embodiment.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned there remains a need to develop a field service management system and method, which may be used to authenticate service personnel to perform a field service operation on an electronic device located at the premises of a customer, to monitor maintenance operations, to maintain a service log, and to perform the auditing of field service data effectively and quickly.

According to one embodiment, a field service operation is carried out on a device at a customer premise by a technician who is authorized to carry out the field service operation on a specific device by issuing a permission slip to the technician. The field service operation refers to the work to be performed on a specific device by a technician. For example, the field service operation may be a ROM update, a device diagnostics, a device refurbishment, a device recall, a device installation/removal, etc. The technician is first authenticated based on the input of a user name and a password of the technician. Then the technician is provided with a work list. The work list is a list of specific devices that require a field service operation. Specific devices are identified by a device identification number (hereinafter “device ID”). In most cases the device ID is the serial number of the device. The work list also contains details such as device location address, phone number, patient name, etc. Each device on the work list also has an associated permission slip. When the technician accepts the work list, the technician gets the permission slips associated with the work list.

A permission slip is issued to the technician after authentication to carry out a field service operation on a device. A permission slip is the set of data that travels with the field service operation from the start of a field service operation to the completion of a field service operation. Each permission slip is associated with a unique service authorization code so that each permission slip may be easily monitored. The permission slip also contains the device ID of the specific device on which a field service operation is to be performed and the user name of the technician who is authorized to perform the service on the specific device.

According to various embodiments of the invention, permission slips may be generic permission slips (GPS) and specific permission slips (SPS). Generic permission slips are issued for devices that are to be serviced in bulk, for example, mass ROM updating of devices in stock. Specific permission slips are issued for the devices that need service as a result of a customer request. These permission slips are issued corresponding to a specific device/patient. The field service management system enforces and ensures that these permission slips are used only on the specific device/patient for which they are intended. The field service management system enforces the use of a permission slip on a specific device by verifying the device ID, when the field service operation is performed (for example such as a new device installation at a patient's home or a device collection from a patient's home). Moreover, the technician is provided with the name, address, and phone number of the location where the device is located, whereby the technician may perform the service operation at the patient's location, if needed.

A service key containing the permission slip for executing a field service operation on a specific device is provided to the technician, when the technician accepts a work list. The service key is a device provided with a writeable storage area to store the permission slip and any associated data so that the service key is adapted to execute a required service operation on a specific device, when the service key is inserted into a specific device. Examples of possible keys include: USB Flash drives, Smart Cards, Magnetic strip cards, Memory Sticks, etc. The technician inserts the received service key containing the permission slip into the device under service. The technician is permitted to carry out or prohibited from carrying out the field service operation based on the device ID stored on the permission slip. The permission slip is closed at the completion of the field service operation on the specific device. The status of the field service operation performed on a device is monitored and tracked at each stage through the permission slip. The field service data are stored in a log.

A service log entry is automatically created when a service operation is performed by the technician. The log entry is stored on the device to be serviced, when the key is inserted into the device, and later uploaded to a device database by the device (e.g., the next time the device connects to the device database). The log contains the service authorization code, the date on which the service is performed, and the details of the service performed, such as service type, ROM version, service software version, etc. Thus a separate field service log is maintained for each device and is accessable through a care management system by a care manager who takes care of patients.

An audit system is provided to track the service history of a device. The device data base and a service database may be audited to verify that each device received the requested service. The complete service records for a particular technician, for a particular device, and for a particular service operation type may be generated by the system by comparing the data on a device data server and a field service server.

Customers and government regulatory agencies may also access the audit system to request audit reports of field service work. The requests include open service requests, completed service requests, device service history records, technician service records, ROM update service lists, device recall lists, device refurbishment lists, device installation/delivery lists, etc. Government regulatory agencies may request audits of field service records to verify regulatory compliance with mandatory recalls or other regulatory requirements.

Customers who manage patient care may request field service and may track field service requests through to their completion. The field service request for a device may include ROM upgrades, refurbishment, delivery/installation, recall, repair, etc. Customers may also request audit reports of field service for a device, of a technician, of a specific type of service, etc.

The audit system may impose and integrate a tracking procedure on the field service process using a permission slip. By issuing permission slips, each field service operation may be tracked from the beginning to the end. The field service operation data may be audited by accessing the device and service databases and the audit reports of serviced devices may be generated. The audit system tracks the flow of field service operation data effectively with a client/server subsystem. The client/server subsystem generates a permission slip for each field service operation and writes the permission slip to the service key. Once the service key has been used for the authorized service, it is accessed by the client/server subsystem to close out the permission slip for traceability. The log entry on the device is uploaded to the device data server for a double check so that a field service operation may be audited by comparing the service log data on two servers in the system (e.g., the field service server and the device data server).

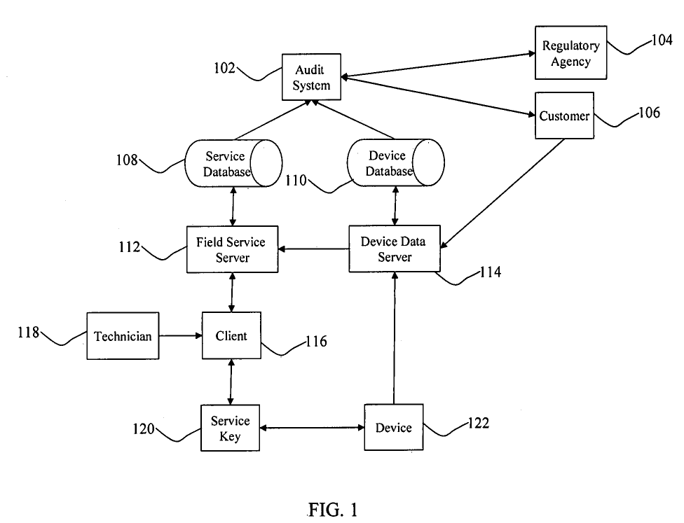

The system uses a removable storage device (service key) to contain software and data to perform a field service operation on the device. The storage device also contains the permission slip and service completion data. The completion data is written on the permission slip, when a service operation is completed. The system also uses a client software program that handles user requests for permission slips. The client requests permission for field service operations and closes completed field service operations. The client writes new service data and reads completed work logs from the storage device (service key). A server software program is used to track a field service operation by issuing a permission slip for a new field service operation and closing out verified field service operation permission slips. Referring now to the drawings and more particularly to FIGS. 1 through 3 where similar reference characters denote corresponding features consistently throughout the figures, there are shown preferred embodiments.

Referring now to FIG. 1, a functional block diagram of a permission based field service management system is illustrated according to an exemplary embodiment of the present invention. Technician 118 is allotted to perform a field service operation and logs into client software system 116 using his/her user name and password and forwards a permission request for performing a field service operation. Client software system 116 refers to a computer software program that allows authorized customers 106 to communicate with a field service server 112. Field service server 112 refers to a computer software program that runs on a centralized computer and provides access to customers 106 through client programs running on the customer's remote computer.

Client software system 116 gets permission data (in the form of a permission slip) containing a service authorization code from a permission slip issue server and writes it on a service key 120 to be issued to technician 118 when technician 118 sends a request for permission slip. The permission slip may be a SPS type permission slip or GPS type permission slip. If the permission slip is a SPS type permission slip, client software system 116 also retrieves a device ID and writes it on the service key 120. The data containing the details of the permission slip and the details of the field service operation are forwarded to user device 122. Client software system 116 also forwards data containing the details of the permission slip to field service server 112. Examples of field service operations include ROM updating, device diagnostics, a device refurbishment, a device recall, a device installation/removal, etc.

Technician 118 may see available work lists and may get permission slips for those work lists. A work list is a list of specific devices 122 that require field service operations. Specific device 122 is identified by device ID. In most cases device ID is the serial number of the device itself. The work list also contains device location address and phone number/patient name. Each device 122 on the work list also has an associated permission slip. When technician 118 accepts the work list, he/she gets the permission slips associated with the work list. Technician 118 may also get generic permission slips for any bulk operations to be performed on device 122.

Once technician 118 accepts permission slips, the slips are written to service key 120. Technician 118 removes the service key 120 and inserts service key 120 into device 122 that requires a field service operation.

Client software system 116 prompts technician 118 to insert a service key 120. Client software system 116 reads the inserted service key 120 to identify whether the inserted service key 120 contains open permission slips or completed permission slips. If any of the inserted permission slips are complete permission slips, client software system 116 allows technician 118 to review the field service operations performed. Further, the technician 118 may close out any open permission slips.

A device data server 114, connected to field service server 112, releases a permission request to technician 118 through field service server 112 and client software system 116 by comparing the data contained in the permission slip with stored service log data received from device 122 under service.

Technician 118 inserts service key 120 into field device 122. Field device 122 checks whether the device ID data contained in the issued permission slip written on the inserted service key 120 is correct. Technician 118 performs the required service field operation(s) based on the approval received from device data server 114. When the inserted permission slip is a specific permission slip and device ID is not correct, then device 122 will display to technician 118 that the device 122 is not correct.

When device 122 is correct or the permission slip is a generic type, the field service operation will be allowed and logged on service key 120 and device 122 under service. Device 122 uploads the field service log entries to device data server 114. This allows device 122 to maintain a separate field service log accessible by an audit system 102, regulatory agencies 104, and a customer care manager, through a care management system.

Once a field service operation is complete, technician 118 removes the service key 120 for insertion into client software system 116. The service log entry is automatically created when a field service operation is performed by technician 118. A log entry is stored on device 122 and later uploaded to a device database 110. The log contains the service authorization code, the date on which the service is performed, and the details of the service performed, such as service type, ROM version, service software version, etc. The updated device data is forwarded from device data server 114 to device database 110 for storage.

Service data is transferred from field service server 112 to a service database 108 for storage. The service log data uploaded from field device 122 to device data server 114 is stored on device database 110. Audit system 102 accesses field service database 108 and device database 110 to retrieve stored service data and stored device data to monitor and audit the field service operations, for instance, to ensure that each device 122 receives the required field service operation. In order to track the service history, device database 110 and field service database 108 may be audited to verify that each device 122 receives the requested field service operation. The complete service records for particular technician 118 or particular device 122 or a particular service operation type may be generated by the field service management system by comparing the data on device data server 114 and field service server 112.

Customers 106 and government regulatory agencies 104 may also access the audit system 102 to forward a request for an audit report and to obtain the audit reports of field service work. Examples of service requests include open service requests, completed service requests, device service history records, technician service records, ROM update service lists, recall lists, refurbishment lists, and installation/delivery lists.

Customers 106 may contact device data server 114 to forward an external field service request. Customers 106 who manage patient care may request a field service operation for a specific patient/device. Such requests include a device recall, ROM update in a device, a device refurbishment, a device repair, a device installation/delivery, etc. When such a request is issued to device data server 114, device data server 114 generates specific permission slips in the field service management system. Additionally, device data server 114 generates work lists that include the address of a device location, so that technicians may identify the location of device 122 on which a field service operation is to be performed.

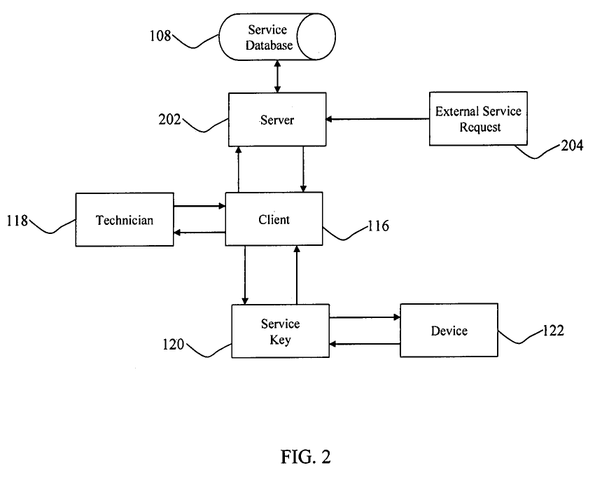

Referring now to FIG. 2, a functional block diagram of a permission based field service client/server subsystem used in a permission based field service management system is shown according to one embodiment of the present invention. Technician 118 logs into client software system 116 using his/her user name and password to carry out a user authentication process. Such authentication process may be used when technician 118 forwards a service authorization request to client software system 116 to carry out a field service operation on device 122. In the user authentication process, technician 118 logs in to establish the traceability for the person responsible for performing the service. Technician 118 forwards the service authorization request to client software system 116 to obtain a generic permission slip for bulk operations such as ROM updates, etc. Technician 118 inserts service key 120 into client software system 116 to obtain a permission slip to execute a field service operation on device 122. The service key 120 is a portable device provided with memory to store the permission slip. The permission slip is a set of data containing the identity of device 122 on which a field service operation is to be performed, the type of service, and the identity of technician 118 performing the field service operation. Multiple types of permission slips may be utilized, including generic permission slips and specific permission slips. Generic permission slips may be used on any device 122 and used for carrying out bulk operations, such as mass ROM updates on a batch of devices. Specific permission slips may be used on any specific device 122 identified with the device serial number. The permission slip is created by server 202 and stored on service key 120.

Client software system 116 forwards user authentication results and service authorization requests received from technician 118 to server 202 to obtain work lists and permission slips. A received work list from server 202 is forwarded to technician 118 by client software system 116. The work list contains a list of devices 122 that require a field service operation. The work list informs technician 118 regarding the location of specific device 122 in which a field service operation is to be performed by technician 118. Each device 122 on the work list contains an associated permission slip. When technician 118 accepts the work list, server system 202 generates a permission slip and passes the generated permission slip to client software system 116. Client software system 116 records and stores the permission slip on service key 120.

Technician 118 inserts service key 120 to device 122 to carry out a field service operation. Device 122 authenticates service key 120 by verifying the device ID recorded with the permission slip stored on service key 120. A service log entry is created after completion of a field service operation and stored on device 122. The stored service log entry is uploaded to server 202, such as, for example, the next time server 202 is connected to field device 122.

Technician 118 removes service key 120 from device 122 after the completion of a field service operation and inserts service key 120 into client software system 116 to close the permission slip. A service verification record regarding the completed field service operation performed on device 122 is created and stored on server 202. The service verification record is a permanent record of service done on device 122. Server 202 writes all service data to service database 108. The service verification record and a service log entry (generated corresponding to the completed field service operation on a field device) are stored on service database 108 connected to server 202.

An external system is connected to server 202 to forward an external service request 204 for device 122. External service request 204 comprises a service authorization request for performing a field service operation on device 122 and a work list of all devices 122 requiring a field service operation. Customers, such as customers 106 of FIG. 1, who manage patient care may request a field service operation for a specific patient/device. Such requests include device recall operation, device ROM updates operation, device refurbishment operation, device repair operation, device installation/delivery operation, etc. When such request is issued to server 202, server 202 generates specific permission slips in the field service management system. Server 202 also generates work lists that include the device location, so that technicians 118 may know the address of where device 122 is installed.

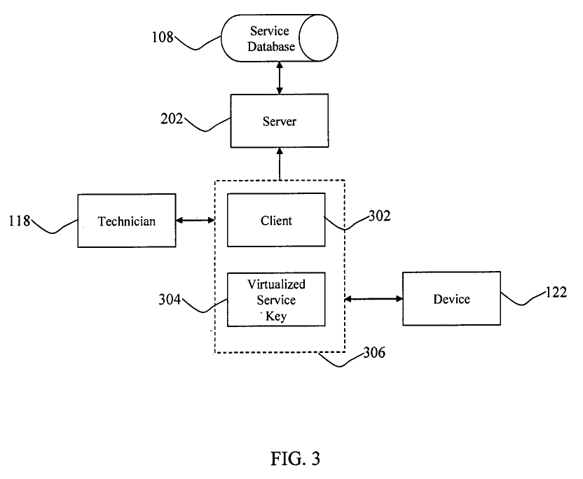

Referring now to FIG. 3, a functional block diagram of a permission based field service client/server subsystem with virtualized service key is illustrated according to one embodiment of the present invention. Technician 118 interactively communicates with the server 202 through a portable client device 306 to acquire a virtualized service key 304 to perform a field service operation on device 122. Portable client device 306 may be a personal digital assistant or a mobile telephone provided with memory to store a client software system 302 and virtualized service key 304. Client software system 302 is operated to communicate with server system 202 through wireless communication system to acquire a work list and a permission slip to carry out a field service on device 122. The received work list is output to technician 118. When technician 118 accepts the work list, the virtualized service key 304 corresponding to the permission slip associated with the field service is generated and transmitted to technician 118. Virtualized service key 304 is an electronic data record containing a key code. Technician 118 is connected to device 122 under service through the portable client device 306 to transmit virtualized service key 304 to device 122 to acquire permission to perform a field service operation on device 122. Once a field service operation is completed, device 122 under service generates and uploads the completed service data to server system 202 through a wireless communication system. Server 202 stores the received service data on service database 108 for auditing the completed field service operation, for instance, to check whether the stipulated guidelines for executing a field service operation is met or followed. Client software system 302 and virtualized service key 304 are stored in a portable client device 306. The virtualized service key 304 initiates the field service operation through a wireless protocol, such as a Bluetooth™ communication system.

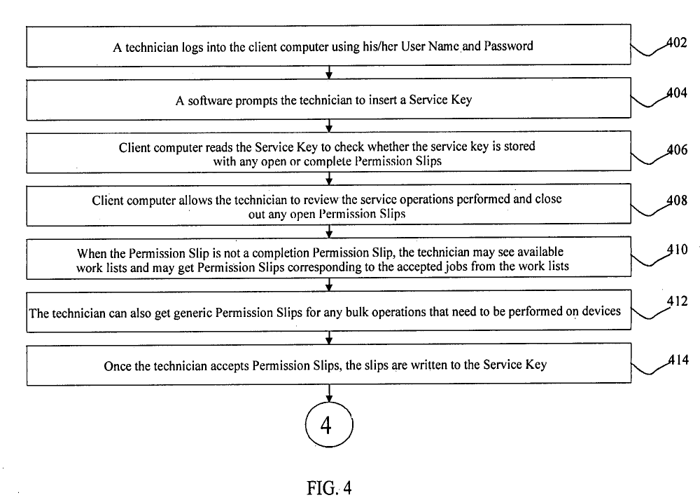

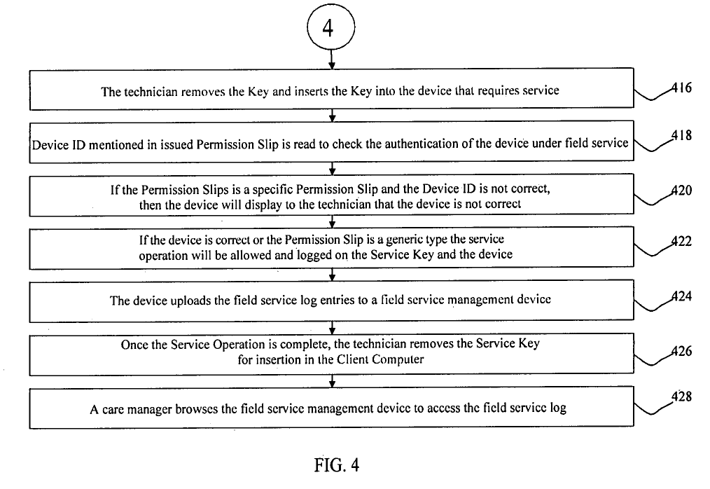

Referring now to FIG. 4, a flowchart explaining the method for performing a field service operation using permission based field service management system is shown in accordance with an exemplary embodiment of the present invention. A technician logs into the client computer using his/her user name and password (402). A software prompts the technician to insert a service key (404). The client computer reads the service key to check whether the service key is stored with any open or complete permission slips (406). The client computer allows the technician to review the service operations performed and close out any open permission slips (408). When the permission slip is not a complete permission slip, the technician may see available work lists and may get permission slips corresponding to the accepted jobs from the work lists (410). The technician may also get generic permission slips for any bulk operations that need to be performed on devices (412). Once the technician accepts permission slips, the slips are written to the service key (414). The service key is a portable device provided with memory to store the permission slip. The service key may be a personal digital assistant or a mobile phone. The technician removes the key and inserts the key into the device that requires service (416). The device ID mentioned in the issued permission slip is read to check the authentication of the device under field service (418). If the permission slip is a specific permission slip and the device ID is not correct, then the device will display to the technician that the device is not correct (420). If the device is correct or the permission slip is a generic type, the service operation will be allowed and logged on the service key and the device (422). The device uploads the field service log entries to a field service management device (424). Once the service operation is complete, the technician removes the service key for insertion in the client computer (426). A care manager browses the field service management device to access the field service log (428).

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A method of performing a field service operation on an electronic device, said method comprising:
authenticating an identity of a technician through a client computer system;
receiving a service key from the technician in said client computer system to receive a permission slip;
obtaining said permission slip from a server computer system, wherein said permission slip is stored on said service key by said client computer system, having communicated with said server computer system;
receiving said service key at said client computer system in order to close said permission slip upon completion of a service task.

2. The method of claim 1, wherein said server computer system has a database system that stores data from said field service operation.

3. The method of claim 1, wherein said permission slip is a packet of data that authenticates said service operation to be performed on said electronic device.

4. The method of claim 1, wherein said service key is a device with a memory that may store said permission slip.

5. The method of claim 1, wherein said service key is adapted to execute said service operation in said electronic device, once said service key is inserted into said electronic device.

6. The method of claim 1, wherein log data of said service operation is stored in said server computer system once said permission slip is closed after completion of said service operation.

7. The method of claim 1, wherein a copy of said log data of said service operation is stored on said electronic device.

8. The method of claim 1, wherein said electronic device is adapted to transfer of said log data to a remote data storage device.

9. A permission based field service client/server subsystem for permission based field service management system, comprising:
a client to receive input user authentication (UA) data and a service authorization record (SAR); and
a server operably connected to said client to receive the SAR to output a work list to a technician through said client and to output a permission slip corresponding to accepted jobs in said work list,
wherein said client receives and writes the permission slip on a service key inserted into said client, to perform field service operation on a specific field device.

10. The subsystem according to claim 9, wherein said server outputs the permission slip corresponding to each field service operation.

11. The subsystem according to claim 9, wherein said permission slip is a generic permission slip (GPS) that may be used on any field device.

12. The subsystem according to claim 9, wherein said permission slip is a specific permission slip (SPS) that may be used on a specific field device that is identified with an identification code.

13. The subsystem according to claim 12, wherein said identification code is the serial number of said specific field device.

14. The subsystem according to claim 9, wherein said service key is a portable device with a memory to store said permission slip.

15. The subsystem according to claim 9, wherein said service key written with said permission slip is insertable within said specific field device requiring a field service operation.

16. The subsystem according to claim 15, wherein said specific field device transfers a device identification code to the service key.

17. The subsystem according to claim 9, wherein said service key stores a data related to said field service operation performed on said specific field device to generate a service log entry (SLE) after completion of said field service operation.

18. The subsystem according to claim 17, wherein said field device receives and stores said SLE after completion of said field service operation.

19. The subsystem according to claim 18, wherein said service key is removable from said specific field device after completion of said field service operation and is insertable into said client to transfer a service verification record (SVR) containing said SLE to said server through said client.

20. The subsystem according to claim 19, further comprising a service database operably connected to said server to receive and store said SVR containing said SLE and service data related to said specific field device.

21. The subsystem according to claim 21, further comprising an external system operably connected to said server to generate and input external service requests.

22. The subsystem according to claim 21, wherein said external system generates service authorization requests and a work list for transfer to said server.
